(19) United States
(12) Patent Application Publication
(10) Pub. No.: US 2022/0092294 A1
(43) Pub. Date: Mar. 24, 2022

(54) METHOD AND SYSTEM FOR FACIAL LANDMARK DETECTION USING FACIAL COMPONENT-SPECIFIC LOCAL REFINEMENT

(71) Applicant: GUANGDONG OPPO MOBILE TELECOMMUNICATIONS CORP., LTD., Dongguan (CN)

(72) Inventors: Runsheng XU, Palo Alto, CA (US); Zibo MENG, Palo Alto, CA (US); Chiuman HO, Palo Alto, CA (US)

(21) Appl. No.: 17/544,264

(22) Filed: Dec. 7, 2021

Related U.S. Application Data
(63) Continuation of application No. PCT/CN2020/091480, filed on May 21, 2020.
(60) Provisional application No. 62/859,857, filed on Jun. 11, 2019.

(51) Int. Cl. G06K 9/00; G06K 9/46

(52) U.S. Cl. CPC G06K 9/00281; G06K 9/4671; G06K 9/00228

(57) ABSTRACT

A method includes: receiving a facial image (204); obtaining a facial shape (206) using the facial image (204); defining, using the facial image (204) and the facial shape (206), a plurality of facial component-specific local regions, wherein each of the facial component-specific local regions includes a corresponding separately considered facial component of a plurality of separately considered facial components from the facial image (204), and the corresponding separately considered facial component of the separately considered facial components corresponds to a corresponding first facial landmark set (208) of a plurality of first facial landmark sets in the facial shape (206); for each of the facial component-specific local regions, performing a cascaded regression method using each of the facial component-specific local regions and a corresponding facial landmark set (208) of the first facial landmark sets to obtain a corresponding facial landmark set (210) of a plurality of second facial landmark sets.

### CROSS-REFERENCE TO RELATED APPLICATION

This application is a continuation of International Application No. PCT/CN2020/091480, filed on May 21, 2020, which claims priority to U.S. Provisional Application No. 62/859,857, filed on Jun. 11, 2019. The entire disclosures of the above applications are incorporated herein by reference.

### BACKGROUND OF DISCLOSURE

### 1. Field of the Disclosure

The present disclosure relates to the field of facial landmark detection, and more particularly, to a method and system for facial landmark detection using facial component-specific local refinement.

### 2. Description of the Related Art

Facial landmark detection plays an essential role in face recognition, face animation, 3D face reconstruction, virtual makeup, etc. The goal of facial landmark detection is to locate fiducial facial key points around facial components and facial contour s in facial images.

### SUMMARY

An object of the present disclosure is to propose a method and system for facial landmark detection using facial component-specific local refinement.

In a first aspect of the present disclosure, a computer-implemented method includes: performing an inference stage method, wherein the inference stage method includes: receiving a first facial image; obtaining a first facial shape using the first facial image; defining, using the first facial image and the first facial shape, a plurality of facial component-specific local regions, wherein each of the facial component-specific local regions includes a corresponding separately considered facial component of a plurality of separately considered facial components from the first facial image, and the corresponding separately considered facial component of the separately considered facial components corresponds to a corresponding first facial landmark set of a plurality of first facial landmark sets in the first facial shape, wherein the corresponding first facial landmark set of the first facial landmark sets includes a plurality of facial landmarks; for each of the facial component-specific local regions, performing a cascaded regression method using each of the facial component-specific local regions and a corresponding facial landmark set of the first facial landmark sets to obtain a corresponding facial landmark set of a plurality of second facial landmark sets.

Each stage of the cascaded regression method includes: extracting a plurality of local features using each of the facial component-specific local regions and a corresponding facial landmark set of a plurality of previous stage facial landmark sets, wherein the step of extracting includes extracting each of the local features from a facial landmark-specific local region around a corresponding facial landmark of the corresponding facial landmark set of the previous stage facial landmark sets, wherein the facial landmark-specific local region is in each of the facial component-specific local regions; and the corresponding facial landmark set of the previous stage facial landmark sets corresponding to a beginning stage of the cascaded regression method is the corresponding facial landmark set of the first facial landmark sets; and organizing the local features based on correlations among the local features to obtain a corresponding facial landmark set of a plurality of current stage facial landmark sets, wherein the corresponding facial landmark set of the current stage facial landmark sets corresponding to a last stage of the cascaded regression method is the corresponding facial landmark set of the second facial landmark sets.

In a second aspect of the present disclosure, a system includes at least one memory and at least one processor. The at least one memory is configured to store program instructions.

The at least one processor is configured to execute the program instructions, which cause the at least one processor to perform steps including: performing an inference stage method, wherein the inference stage method includes: receiving a first facial image; obtaining a first facial shape using the first facial image; defining, using the first facial image and the first facial shape, a plurality of facial component-specific local regions, wherein each of the facial component-specific local regions includes a corresponding separately considered facial component of a plurality of separately considered facial components from the first facial image, and the corresponding separately considered facial component of a plurality of separately considered facial components corresponds to a corresponding first facial landmark set of the first facial landmark sets in the first facial shape, wherein the corresponding first facial landmark set of the first facial landmark sets includes a plurality of facial landmarks; for each of the facial component-specific local regions, performing a cascaded regression method using each of the facial component-specific local regions and a corresponding facial landmark set of the first facial landmark sets to obtain a corresponding facial landmark set of a plurality of second facial landmark sets.

Each stage of the cascaded regression method includes: extracting a plurality of local features using each of the facial component-specific local regions and a corresponding facial landmark set of a plurality of previous stage facial landmark sets, wherein the step of extracting includes extracting each of the local features from a facial landmark-specific local region around a corresponding facial landmark of the corresponding facial landmark set of the previous stage facial landmark sets, wherein the facial landmark-specific local region is in each of the facial component-specific local regions; and the corresponding facial landmark set of the previous stage facial landmark sets corresponding to a beginning stage of the cascaded regression method is the corresponding facial landmark set of the first facial landmark sets; and organizing the local features based on correlations among the local features to obtain a corresponding facial landmark set of a plurality of current stage facial landmark sets, wherein the corresponding facial landmark set of the current stage facial landmark sets corresponding to a last stage of the cascaded regression method is the corresponding facial landmark set of the second facial landmark sets.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram illustrating inputting, processing, and outputting hardware modules in a terminal in accordance with an embodiment of the present disclosure.

FIG. 2 is a block diagram illustrating a facial landmark detector in accordance with an embodiment of the present disclosure.

FIG. 3 is a diagram illustrating sixty eight numbered facial landmarks for facial landmarks in examples in the present disclosure to be referred to.

FIG. 4 is a block diagram illustrating a global facial landmark obtaining module in the facial landmark detector in FIG. 2 in accordance with an embodiment of the present disclosure.

FIG. 5 is a block diagram illustrating a cropping module in the facial landmark detector in FIG. 2 in accordance with an embodiment of the present disclosure.

FIG. 6 is a block diagram illustrating facial component-specific local refining modules in the facial landmark detector in FIG. 2 in accordance with an embodiment of the present disclosure.

FIG. 7 is block diagram illustrating a merging module in the facial landmark detector in FIG. 2 in accordance with an embodiment of the present disclosure.

FIG. 8 is a block diagram illustrating a cropping module in the facial landmark detector in FIG. 2 in accordance with another embodiment of the present disclosure.

FIG. 9 is a block diagram illustrating a cropping module in the facial landmark detector in FIG. 2 in accordance with still another embodiment of the present disclosure.

FIG. 10 is a block diagram illustrating cascaded regression stages in one of the facial component-specific local refining modules in FIG. 6 in accordance with an embodiment of the present disclosure.

FIG. 11 is a block diagram illustrating a local feature extracting module and a local feature organizing module in each stage of the cascaded regression stages in FIG. 10 in accordance with an embodiment of the present disclosure.

FIG. 12A is a block diagram illustrating a plurality of facial landmark-specific local feature mapping functions used in the local feature extracting module (in FIG. 11) of a beginning stage of the cascaded regression stages (in FIG. 10) in accordance with an embodiment of the present disclosure.

FIG. 12B is a block diagram illustrating one of the facial landmark-specific local feature mapping functions in FIG. 12A implemented by a random forest in accordance with an embodiment of the present disclosure.

FIG. 13 is a block diagram illustrating a local feature concatenating module, a facial component-specific projecting module, and a facial landmark set incrementing module in the local feature organizing module in FIG. 11 in accordance with an embodiment of the present disclosure.

FIG. 14 is a block diagram illustrating cascaded training stages for the cascaded regression stages in FIG. 10 in accordance with an embodiment of the present disclosure.

FIG. 15 is a block diagram illustrating a facial landmark-specific local feature mapping function training module and a facial component-specific projection matrix training module in one of the cascaded training stages in FIG. 14 in accordance with an embodiment of the present disclosure.

FIG. 16 is a block diagram illustrating a joint detection module implementing the global facial landmark obtaining module in FIG. 4 in accordance with an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

Same reference numerals among different figures indicate substantially the same elements for one of which description is applicable to the others.

As used here, a device, an element, a method, or a step being employed as described by using a term such as “use”, or “from” refers to a case in which the device, the element, the method, or the step is directly employed, or indirectly employed through an intervening device, an intervening element, an intervening method, or an intervening step.

As used here, a term “obtain” used in cases such as “obtaining A” refers to receiving “A” or outputting “A” after operations.

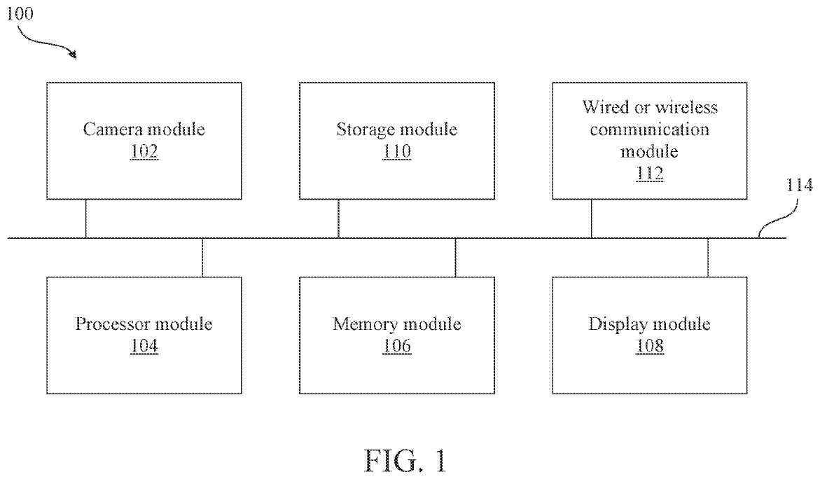

FIG. 1 is a block diagram illustrating inputting, processing, and outputting hardware modules in a terminal 100 in accordance with an embodiment of the present disclosure. Referring to FIG. 1, the terminal 100 includes a camera module 102, a processor module 104, a memory module 106, a display module 108, a storage module 110, a wired or wireless communication module 112, and buses 114. In an embodiment, the terminal 100 may be cell phones, smartphones, tablets, notebook computers, desktop computers, or any electronic device having enough computing power to perform facial landmark detection.

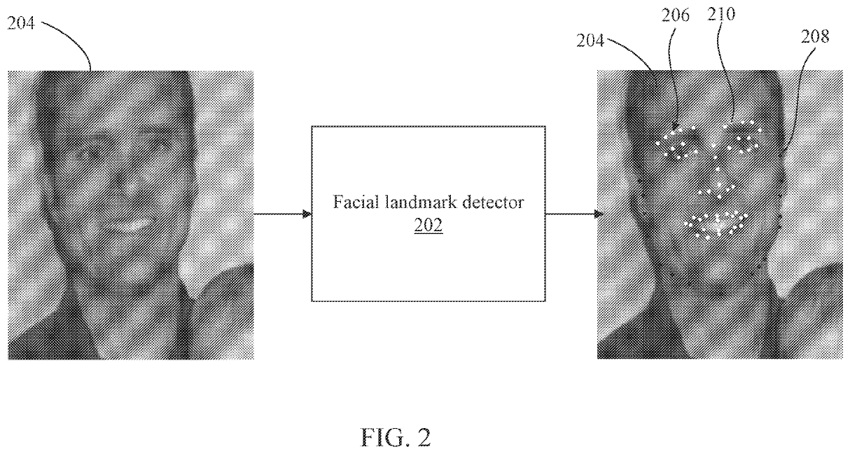

The camera module 102 is an inputting hardware module and is configured to capture a facial image 204 (labeled in FIG. 2) that is to be transmitted to the processor module 104 through the buses 114. In an embodiment, the camera module 102 includes an RGB camera, or a grayscale camera.

In another embodiment, the facial image 204 may be obtained using another inputting hardware module, such as the storage module 110, or the wired or wireless communication module 112. The storage module 110 is configured to store the facial image 204 that is to be transmitted to the processor module 104 through the buses 114. The wired or wireless communication module 112 is configured to receive the facial image 204 from a network through wired or wireless communication, wherein the facial image 204 is to be transmitted to the processor module 104 through the buses 114.

The memory module 106 stores inference stage program instructions, and the inference stage program instructions are executed by the processor module 104, which causes the processor module 104 to perform an inference stage method of facial landmark detection using facial component-specific local refinement to generate a facial shape 206 (labeled in FIG. 2), which is to be described with reference to FIGS. 2 to 13.

In an embodiment, the memory module 106 may be a transitory or non-transitory computer-readable medium that includes at least one memory.

In an embodiment, the processor module 104 includes at least one processor that sends signals directly or indirectly to and/or receives signals directly or indirectly from the camera module 102, the memory module 106, the display module 108, the storage module 110, and the wired or wireless communication module 112 via the buses 114.

In an embodiment, the at least one processor may be central processing unit (s) (CPU(s)), graphics processing unit (s) (GPU(s)), and/or digital signal processor(s) (DSP(s)). The CPU (s) may send the frames, some of the program instructions and other data or instructions to the GPU(s), and/or DSP(s) via the buses 114.

The display module 108 is an outputting hardware module and is configured to display the facial shape 206 on the facial image 204, or an application result obtained using the facial shape 206 on the facial image 204 that is received from the processor module 104 through the buses 114.

The application result may be from, for example, face recognition, face animation, 3D face reconstruction, and applying virtual makeup.

In another embodiment, the facial shape 206 on the facial image 204, or the application result obtained using the facial shape 206 on the facial image 204 may be output using another outputting hardware module, such as the storage module 110, or the wired or wireless communication module 112.

The storage module 110 is configured to store the facial shape 206 on the facial image 204, or the application result obtained using the facial shape 206 on the facial image 204 that is received from the processor module 104 through the buses 114.

The wired or wireless communication module 112 is configured to transmit the facial shape 206 on the facial image 204, or the application result obtained using the facial shape 206 on the facial image 204 to the network through wired or wireless communication, wherein the facial shape 206 on the facial image 204, or the application result obtained using the facial shape 206 on the facial image 204 is received from the processor module 104 through the buses 114.

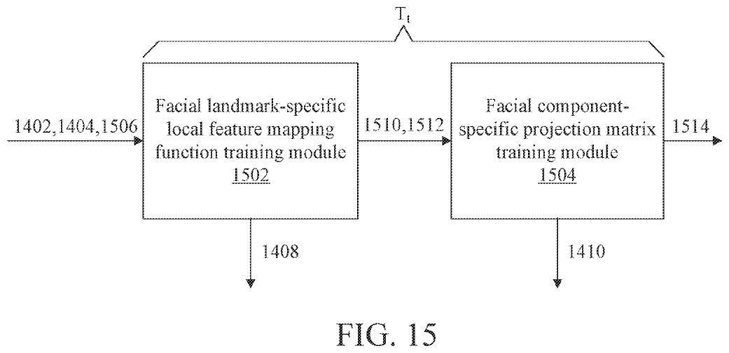

In an embodiment, the memory module 106 further stores training stage program instructions, and the training stage program instructions are executed by the processor module 104, which causes the processor module 104 to perform a training stage method of facial landmark detection using facial component-specific local refinement, which is to be described with reference to FIGS. 14 to 15.

In the above embodiment, the terminal 100 is one type of computing system all of components of which are integrated together by the buses 114. Other types of computing systems such as a computing system that has a remote camera module instead of the camera module 102 are within the contemplated scope of the present disclosure.

In the above embodiment, the memory module 106 and the processor module 104 of the terminal 100 correspondingly store and execute inference stage program instructions and training stage program instructions. Other types of computing systems such as a computing system which includes different terminals correspondingly for inference stage program instructions and training stage program instructions are within the contemplated scope of the present disclosure.

FIG. 2 is a block diagram illustrating a facial landmark detector 202 in accordance with an embodiment of the present disclosure. The facial landmark detector 202 is configured to receive a facial image 204, perform an inference stage method of facial landmark detection using facial component-specific local refinement, and output a facial shape 206.

The facial shape 206 includes a plurality of facial landmarks. The facial shape 206 is shown on the facial image 204 for indicating locations of the facial landmarks with respect to facial components and a facial contour in the facial image 204. Throughout the present disclosure, facial landmarks are shown on facial images for a similar reason. In an example, a number of the facial landmarks is sixty eight.

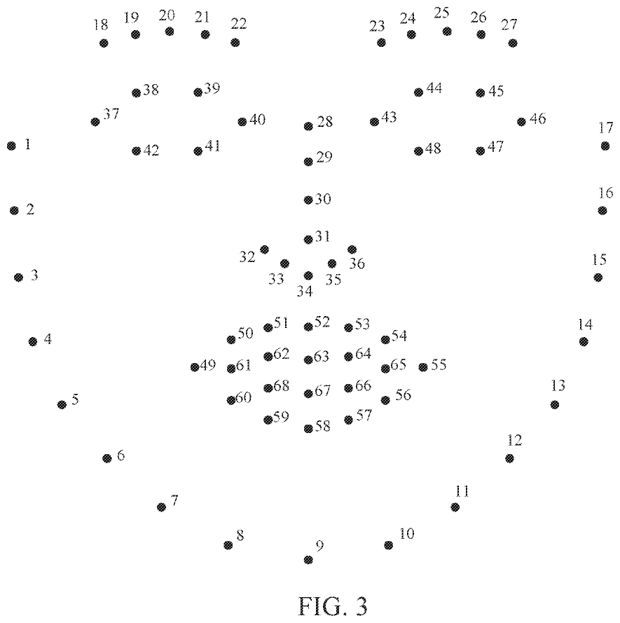

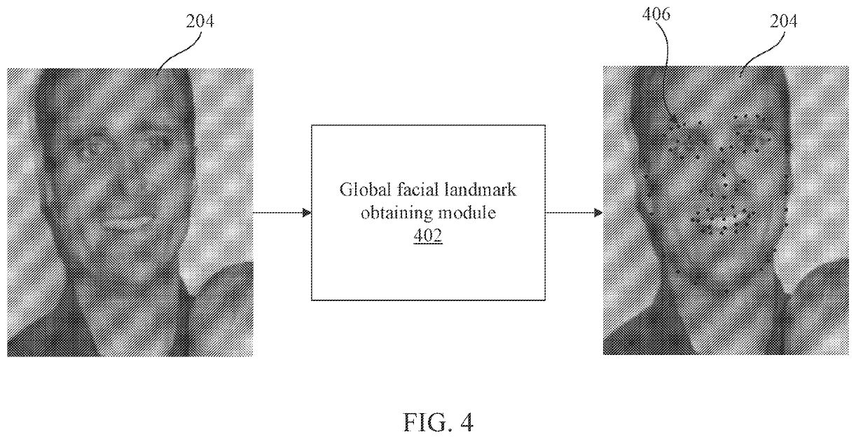

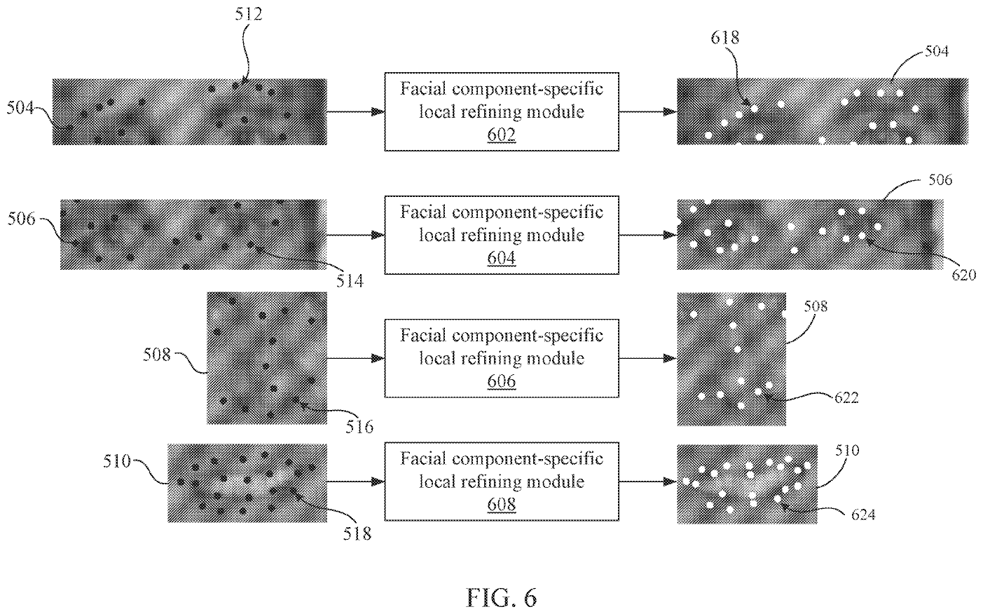

FIG. 3 is a diagram illustrating sixty eight numbered facial landmarks for facial landmarks in examples in the present disclosure to be referred to. Referring to FIGS. 2 and 3, a facial landmark 208 of the facial landmarks is the facial landmark (17) of the facial shape 206, and the facial landmark 210 of the facial landmarks is the facial landmark (24) of the facial shape 206. The facial landmarks are separated into a first set obtained by a global facial landmark obtaining module 402 in FIG. 4 and a second set obtained by facial component-specific local refining modules 602 to 608 in FIG. 6. Each facial landmark in the first set is indicated by a point style used by the facial landmark 208 and each facial landmark in the second set is indicated by a point style used by the facial landmark 210.

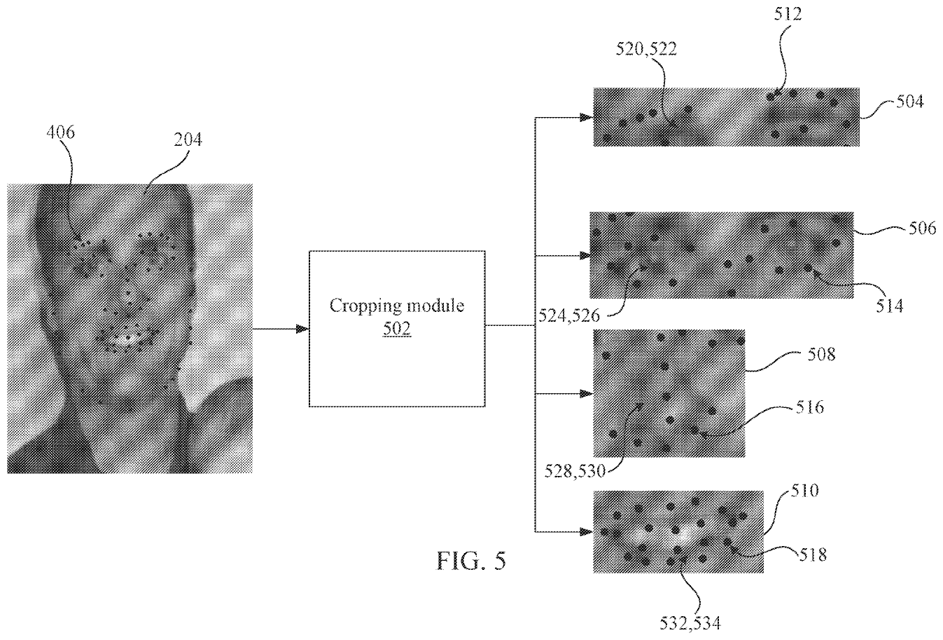

The facial landmark detector 202 includes the global facial landmark obtaining module 402 to be described with reference to FIG. 4, a cropping module 502 to be described with reference to FIG. 5, the facial component-specific local refining modules 602 to 608 to be described with reference to FIG. 6, and a merging module 702 to be described with reference to FIG. 7.

FIG. 4 is a block diagram illustrating the global facial landmark obtaining module 402 in the facial landmark detector 202 in FIG. 2 in accordance with an embodiment of the present disclosure. The global facial landmark obtaining module 402 is configured to receive the facial image 204 and obtain a facial shape 406 using the facial image 204.

Referring to FIGS. 3 and 4, in an embodiment, the facial shape 406 includes a plurality of facial landmarks (1) to (68) globally for a face (i.e. for the whole face) in the facial image 204. The facial landmarks (1) to (68) in the facial shape 406 are the facial landmarks (1) to (17) for the facial contour in the facial image 204, the facial landmarks (18) to (27) for eyebrows in the facial image 204, the facial landmarks (37) to (48) for eyes in the facial image 204, the facial landmarks (28) to (36) for a nose in the facial image 204, and the facial landmarks (49) to (68) for a mouth in the facial image 204.

FIG. 5 is a block diagram illustrating the cropping module 502 in the facial landmark detector 202 in FIG. 2 in accordance with an embodiment of the present disclosure. The cropping module 502 is configured to define, using the facial image 204 and the facial shape 406, a plurality of facial component-specific local regions 504 to 510.

Each of the facial component-specific local regions 504 to 510 includes a corresponding separately considered facial component 520, 524, 528, or 532 of a plurality of separately considered facial components 520, 524, 528, and 532 from the facial image 204.

In an embodiment, the separately considered facial components 520, 524, 528, and 532 are separated according to facial features 522, 526, 530, and 534.

In the embodiment in FIG. 5, the facial features 522, 526, 530, and 534 are functionally grouped. The facial feature 522 is two eyebrows in the facial component-specific local regions 504. The facial feature 526 is two eyes in the facial component-specific local regions 506. The facial feature 530 is a nose in the facial component-specific local regions 508. The facial feature 534 is a mouth in the facial component-specific local regions 504. The two eyebrows are functionally grouped because, for example, they both provide a function of keeping rain and sweat out of the two eyes. The two eyes are functionally grouped because, for example, they work together to provide vision.

The corresponding separately considered facial component 520, 524, 528, or 532 of the separately considered facial components 520, 524, 528, and 532 corresponds to a corresponding facial landmark set 512, 514, 516, or 518 of a plurality of facial landmark sets 512 to 518 in the facial shape 406. The corresponding facial landmark set 512, 514, 516, or 518 of the facial landmark sets 512 to 518 includes a plurality of facial landmarks.

Referring to FIGS. 3 and 5, for example, the facial landmark set 512 of the facial landmark sets 512 to 518 includes the facial landmarks (18) to (27) of the facial shape 406. The facial landmark set 514 of the facial landmark sets 512 to 518 includes the facial landmarks (37) to (48) of the facial shape 406. The facial landmark set 516 of the facial landmark sets 512 to 518 includes the facial landmarks (28) to (36) of the facial shape 406. The facial landmark set 518 of the facial landmark sets 512 to 518 includes the facial landmarks (49) to (68) of the facial shape 406.

After the global facial landmark obtaining module 402 output s the facial shape 406 that includes the facial landmarks (18) to (27) that are known to identify locations of the eyebrows in the facial image 204, the facial landmarks (37) to (48) that are known to identify locations of the eyes in the facial image 204, and the facial landmarks (28) to (36) that are known to identify locations of the nose in the facial image 204, and the facial landmarks (49) to (68) that are known to identify locations of the mouth in the facial image 204, the cropping module 502 is able to use the facial shape 406 to define the facial component-specific local regions 504 to 510.

In an embodiment as shown in FIG. 5, the step of defining includes defining each of the facial component-specific local regions 504 to 510 by cropping such that separately considered facial components (524, 528, 532) , (520, 528, 532) , (520, 524, 532) , or (520, 524, 528) other than the corresponding separately considered facial component 520, 524, 528, or 532 of the separately considered facial components 520, 524, 528, and 532 are at least partially removed. The facial landmark sets 512 to 518 are correspondingly located on the facial component-specific local regions 504 to 510 which are separated.

In the above embodiment, the step of defining includes defining each of the facial component-specific local regions 504 to 510 by cropping. Therefore, the facial landmark sets 512 to 518 are correspondingly located on the facial component-specific local regions 504 to 510 which are separated.

Other ways to define each of facial component-specific local regions such as using coordinates of corresponding corners of each of the facial component-specific local regions in a facial image to define a corresponding boundary of each of the facial component-specific local regions in the facial image are within the contemplated scope of the present disclosure. Therefore, facial landmark sets are correspondingly located on the facial component-specific local regions which are all in the facial image. In the above embodiment, a shape of each of the facial component-specific local regions 504 to 510 is a rectangle. Other shapes for any of the facial component-specific local regions such as a circle are within the contemplated scope of the present disclosure.

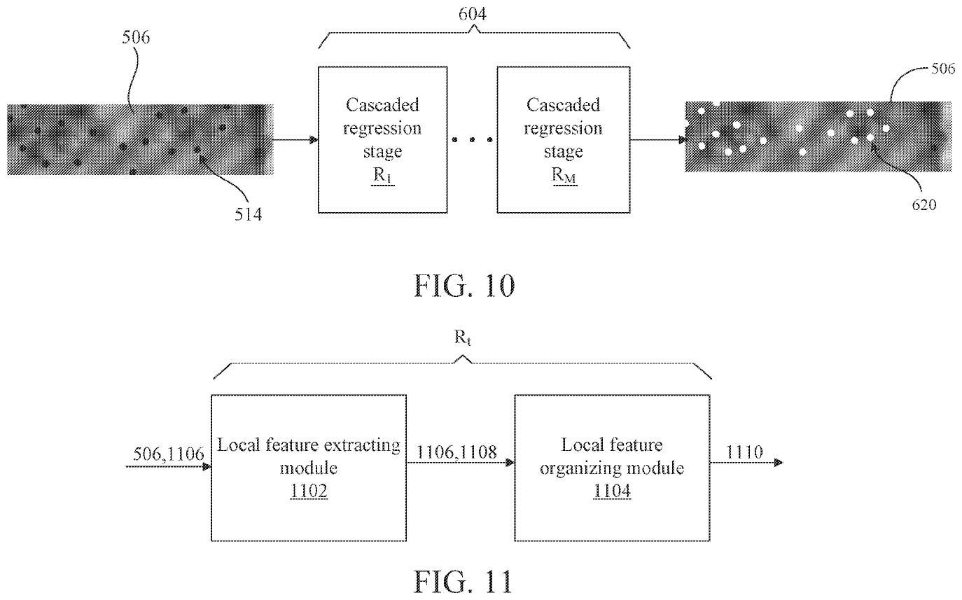

FIG. 6 is a block diagram illustrating the facial component-specific local refining modules 602 to 608 in the facial landmark detector 202 in FIG. 2 in accordance with an embodiment of the present disclosure. For each of the facial component-specific local regions 504 to 510, a corresponding facial component-specific local refining module 602, 604, 606, or 608 of the facial component-specific local refining modules 602 to 608 is configured to receive each of the facial component-specific local regions 504 to 510, perform a cascaded regression method using each of the facial component-specific local regions 504 to 510 and a corresponding facial landmark set 512, 514, 516, or 518 of the facial landmark sets 512 to 518 to obtain a corresponding facial landmark set 618, 620, 622, or 624 of a plurality of facial landmark sets 618 to 624. Details of an exemplarily one of the facial component-specific local refining modules 602 to 608 are to be described with reference to FIGS. 10 to 13.

FIG. 7 is block diagram illustrating the merging module 702 in the facial landmark detector 202 in FIG. 2 in accordance with an embodiment of the present disclosure. The merging module 702 is configured to receive the facial landmark sets 618 to 624, and a facial landmark set 704 in the facial shape 406, and merge the facial landmark sets 618 to 624 correspondingly located on the facial component-specific local regions 504 to 510 which are separated and the facial landmark set 704 in the facial shape 406 into a facial shape 206. The facial landmark set 704 corresponds to the facial contour in facial image 204 and includes the facial landmarks (1) to (17) in the facial shape 406.

In the above embodiment, the step of defining includes defining each of the facial component-specific local regions 504 to 510 by cropping. The step of merging includes merging the facial landmark sets 618 to 624 correspondingly located on the facial component-specific local regions 504 to 510 which are separated. For the other way that defines each of the facial component-specific local regions by defining the corresponding boundary of each of the facial component-specific local regions in the facial image, facial landmark sets are correspondingly located on the facial component-specific local regions which are in the facial image. Therefore, the step of merging may not be necessary.

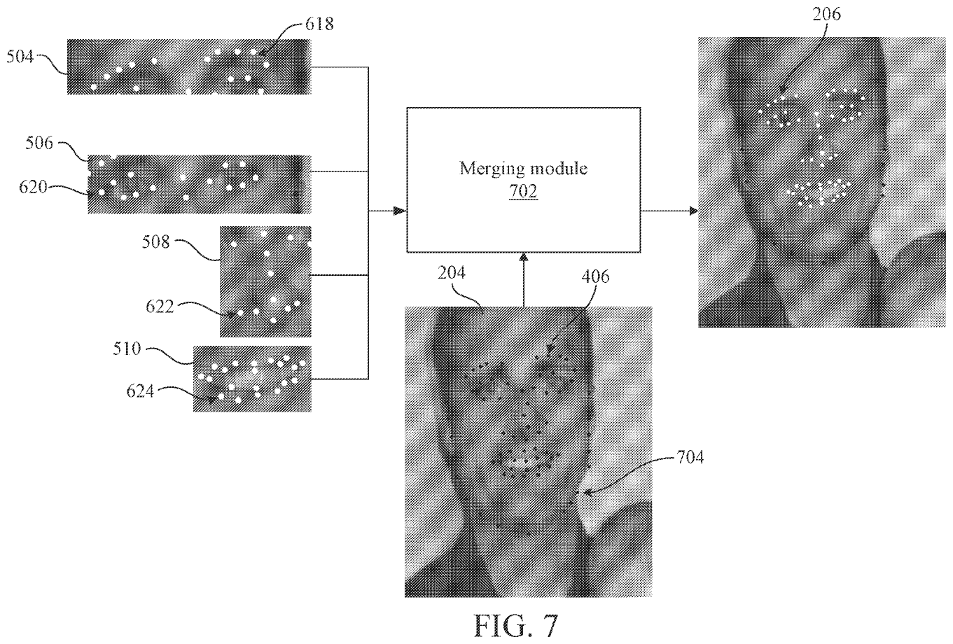

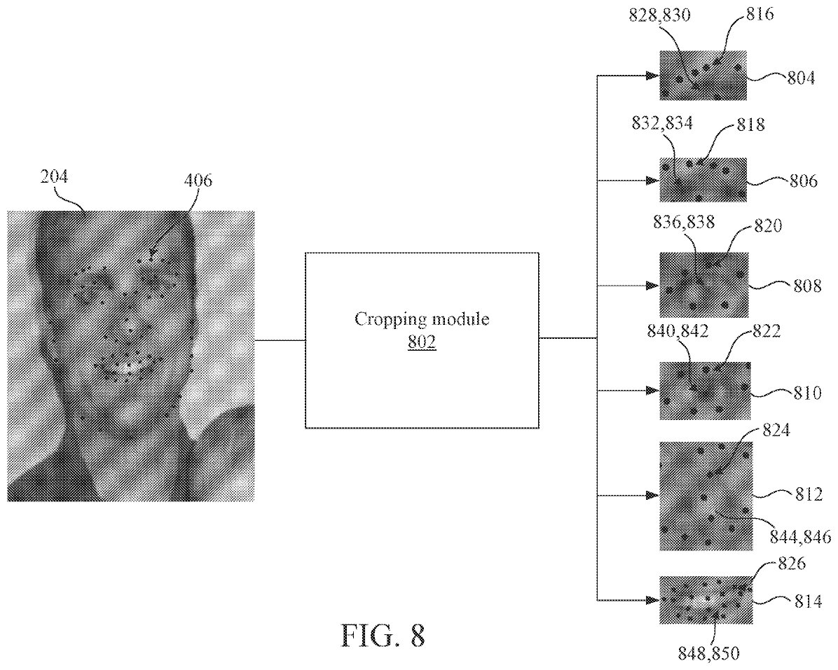

FIG. 8 is a block diagram illustrating a cropping module 802 in the facial landmark detector 202 in FIG. 2 in accordance with another embodiment of the present disclosure. Compared to the cropping module 502 in FIG. 5, the cropping module 802 is configured to define, using the facial image 204 and the facial shape 406, a plurality of facial component-specific local regions 804 to 814. Each of the facial component-specific local regions 804 to 814 includes a corresponding separately considered facial component 828, 832, 836, 840, 844, or 848 of a plurality of separately considered facial components 828, 832, 836, 840, 844, and 848 from the facial image 204.

In an embodiment, the separately considered facial components 828, 832, 836, 840, 844, and 848 are separated according to facial features 830, 834, 838, 842, 846, and 850. In the embodiment in FIG. 8, the facial features 828, 832, 836, 840, 844, and 848 are non-functionally grouped. The facial feature 830 is a left eyebrow in the facial component-specific local regions 804. The facial feature 834 is a right eyebrow in the facial component-specific local regions 806. The facial feature 838 is a left eye in the facial component-specific local regions 808. The facial feature 842 is a right eye in the facial component-specific local regions 810. The facial feature 846 is a nose in the facial component-specific local regions 812. The facial feature 850 is a mouth in the facial component-specific local regions 814.

The corresponding separately considered facial component 828, 832, 836, 840, 844, or 848 of the separately considered facial components 828, 832, 836, 840, 844, and 848 corresponds to a corresponding facial landmark set 816, 818, 820, 822, 824, or 826 of a plurality of facial landmark sets 816 to 826 in the facial shape 406. The corresponding facial landmark set 816, 818, 820, 822, 824, or 826 of the facial landmark sets 816 to 826 includes a plurality of facial landmarks. Referring to FIGS. 3 and 8, for example, the facial landmark set 816 of the facial landmark sets 816 to 826 includes the facial landmarks (18) to (22) of the facial shape 406. The facial landmark set 818 of the facial landmark sets 816 to 826 includes the facial landmarks (23) to (27) of the facial shape 406. The facial landmark set 820 of the facial landmark sets 816 to 826 includes the facial landmarks (37) to (40) of the facial shape 406. The facial landmark set 822 of the facial landmark sets 816 to 826 includes the facial landmarks (43) to (46) of the facial shape 406. The facial landmark set 824 of the facial landmark sets 816 to 826 includes the facial landmarks (28) to (36) of the facial shape 406. The facial landmark set 826 of the facial landmark sets 816 to 826 includes the facial landmarks (49) to (68) of the facial shape 406. The rest of description for the facial landmark detector 202 including the cropping module 502 can be applied mutatis mutandis to the facial landmark detector 202 including the cropping module 802.

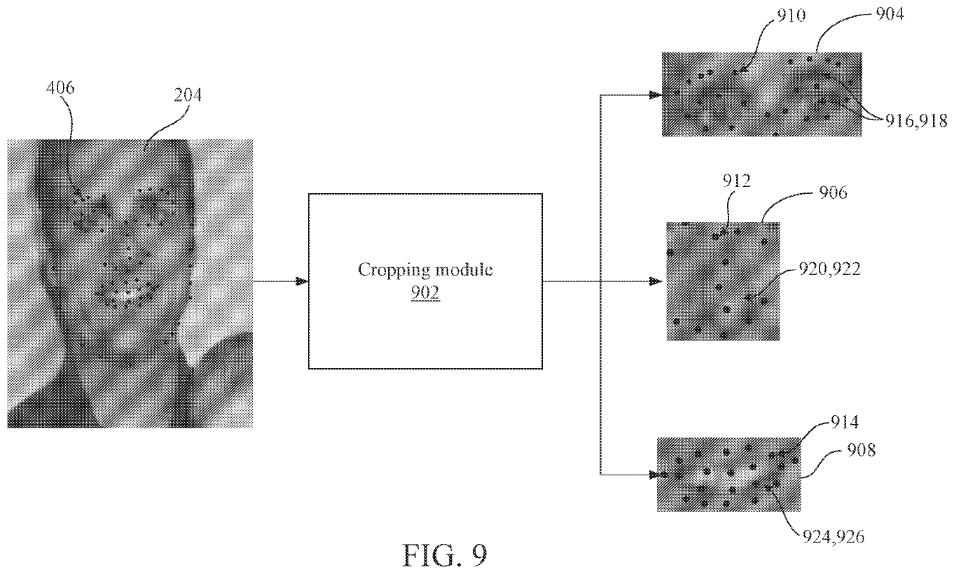

FIG. 9 is a block diagram illustrating the cropping module 902 in the facial landmark detector 202 in FIG. 2 in accordance with an embodiment of the present disclosure. Compared to the cropping module 502 in FIG. 5, the cropping module 902 is configured to define, using the facial image 204 and the facial shape 406, a plurality of facial component-specific local regions 904 to 908. Each of the facial component-specific local regions 904 to 908 includes a corresponding separately considered facial component 916, 920, or 924 of a plurality of separately considered facial components 916, 920, and 924 from the facial image 204.

In an embodiment in FIG. 9, the separately considered facial components 916, 920, and 924 are separated according to senses. The separately considered facial component 916 is a sight-associated sense component 918 and is two eyebrows and two eyes in the facial component-specific local regions 904. The separately considered facial component 920 is a smell-associated sense component 922 and is a nose in the facial component-specific local regions 906. The separately considered facial component 924 is a taste-associated sense component 926 and is a mouth in the facial component-specific local regions 908.

The corresponding separately considered facial component 916, 920, or 924 of the separately considered facial components 916, 920, and 924 corresponds to a corresponding facial landmark set 910, 912, or 914 of a plurality of facial landmark sets 910 to 914 in the facial shape 406. The corresponding facial landmark set 910, 912, or 914 of the facial landmark sets 910 to 914 includes a plurality of facial landmarks. Referring to FIGS. 3 and 5, for example, the facial landmark set 910 of the facial landmark sets 910 to 914 includes the facial landmarks (18) to (27) and the facial landmarks (37) to (48) of the facial shape 406. The facial landmark set 912 of the facial landmark sets 910 to 914 includes the facial landmarks (28) to (36) of the facial shape 406. The facial landmark set 914 of the facial landmark sets 910 to 914 includes the facial landmarks (49) to (68) of the facial shape 406. The rest of description for the facial landmark detector 202 including the cropping module 502 can be applied mutatis mutandis to the facial landmark detector 202 including the cropping module 902.

FIG. 10 is a block diagram illustrating cascaded regression stages R1 to RM in one of the facial component-specific local refining modules 602 to 608 in FIG. 6 in accordance with an embodiment of the present disclosure. In the following, the description for each of facial component-specific local refining modules 602 to 608 is described first and without reference to the figures. Then, the facial component-specific local refining module 604 is used as an example and is described with reference to FIG. 10. For simplicity, the description with reference to FIGS. 11 to 13 only mentions the facial component-specific local refining module 604 as an example. The conversion of the description of the facial component-specific local refining module 604 into the description of each of the facial component-specific local refining module 604 to arrive at the appended claims may use the description with reference to FIG. 10 as an example.

For each of the facial component-specific local regions, a corresponding facial component-specific local refining module of the facial component-specific local refining modules is configured to receive each of the facial component-specific local regions, perform a cascaded regression method using each of the facial component-specific local regions and a corresponding first facial landmark set of first facial landmark sets to obtain a corresponding second facial landmark set of a plurality of second facial landmark sets.

The corresponding facial component-specific local refining module of the facial component-specific local refining modules includes a plurality of cascaded regression stages. Each of the cascaded regression stages is configured to receive each of the facial component-specific local regions and a facial landmark set of a plurality of previous stage facial landmark sets corresponding to each of the facial component-specific local regions, perform a stage of the cascaded regression method, and output a facial landmark set of a plurality of current stage facial landmark sets corresponding to each of the facial component-specific local regions.

The facial landmark set of the previous stage facial landmark sets corresponding to a beginning stage of the cascaded regression stages is the corresponding facial landmark set of the first facial landmark sets. The facial landmark set of the current stage facial landmark sets for a stage of the cascaded regression stages becomes the facial landmark set of the previous stage facial landmark sets for another stage immediately following the stage. The facial landmark set of the current stage facial landmark sets corresponding to a last stage of the cascaded regression stages is the corresponding facial landmark set of the second facial landmark sets.

For example, the facial component-specific local refining module 604 is configured to receive the facial component-specific local region 506, perform the cascaded regression method using the facial component-specific local region 506 and the facial landmark set 514 to obtain the facial landmark set 620. The facial component-specific local refining module 604 includes a plurality of cascaded regression stages R₁ to R_{M}. Each of the cascaded regression stages R₁ to R_{M} is configured to receive the facial component-specific local region 506 and a previous stage facial landmark set 1106 (labeled in FIG. 11) , perform steps in a stage of the cascaded regression method, and output a current stage facial landmark set 1110 (labeled in FIG. 11) . The previous stage facial landmark set 1106 corresponding to a beginning stage R₁ of the cascaded regression stages R₁ to R_{M} is the facial landmark set 514. The current stage facial landmark set 1110 for a stage Rₜ (labeled in FIG. 11) of the cascaded regression stages R₁ to R_{M} becomes the previous stage facial landmark set 1106 for another stage Rₜ₊₁ immediately following the stage Rₜ. The current stage facial landmark set 1110 corresponding to a last stage R_{M} of the cascaded regression stages R₁ to R_{M} is the facial landmark set 620.

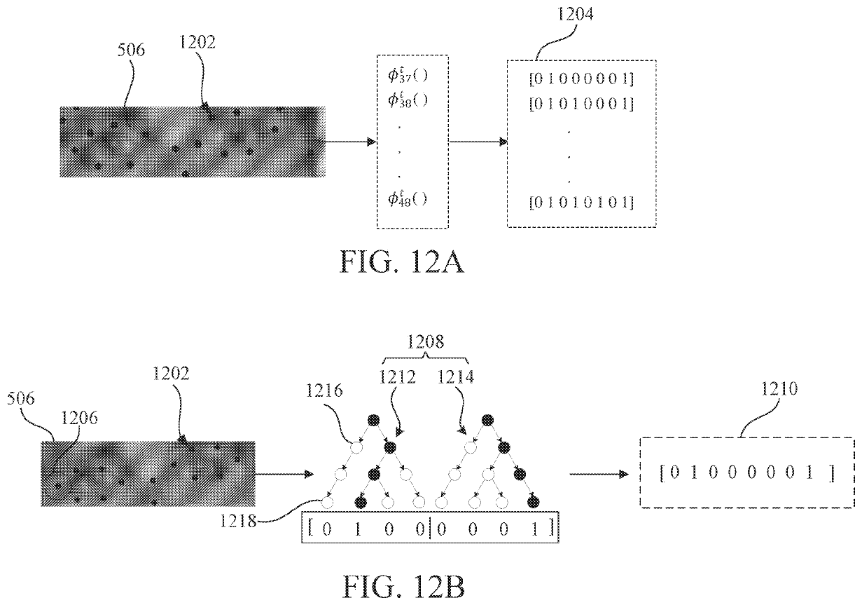

FIG. 11 is a block diagram illustrating a local feature extracting module 1102 and a local feature organizing module 1104 in each stage Rₜ of the cascaded regression stages R₁ to R_{M} in FIG. 10 in accordance with an embodiment of the present disclosure. Each stage Rₜ of the cascaded regression stages R₁ to R_{M} includes a local feature extracting module 1102 and a local feature organizing module 1104. The local feature extracting module 1102 is configured to receive the facial component-specific local region 506 and the previous stage facial landmark set 1106, extract a plurality of local features 1108 using the facial component-specific local region 506 and the previous stage facial landmark set 1106, and output the local features 1108. In FIGS. 12A and 12B, the local feature extracting module 1102 of the beginning stage R₁ of the cascaded regression stages R₁ to R_{M} (shown in FIG. 10) is used as an example for illustration.

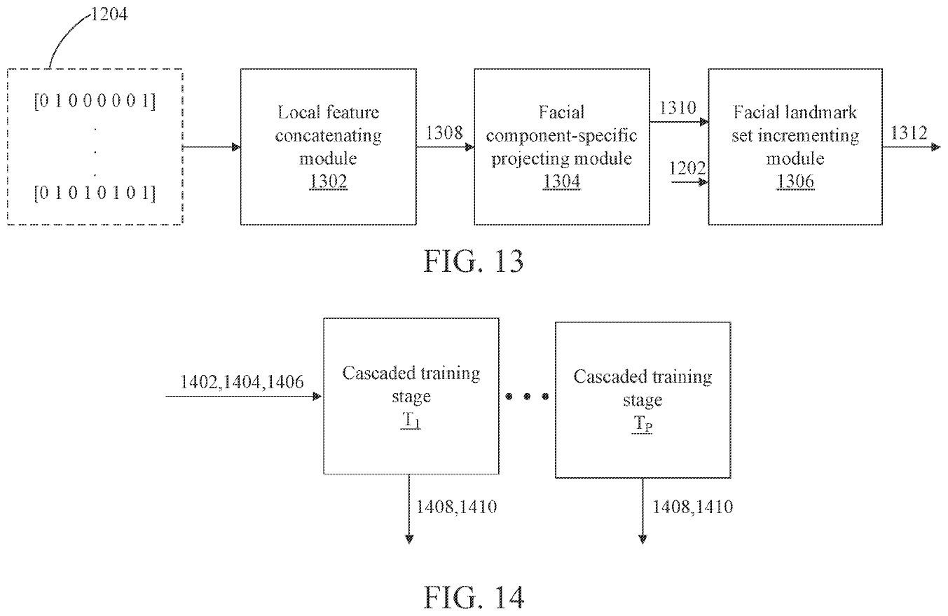

The description for the local feature extracting module 1102 of the beginning stage R₁ of the cascaded regression stages R₁ to R_{M} can be applied mutatis mutandis to the local feature extracting module 1102 of any other stage of the cascaded regression stages R₁ to R_{M}. Referring to FIGS. 3, 11, 12A, and 12B, the step of extracting includes extracting each (e.g., 1210) of the local features (e.g., 1204) from a facial landmark-specific local region (e.g., 1206) around a corresponding facial landmark (e.g., facial landmark (37)) of the previous stage facial landmark set (e.g., 1202). The facial landmark-specific local region (e.g., 1206) is in the facial component-specific local region (e.g., 506). Referring to FIG. 11, the local feature organizing module 1104 is configured to receive the previous stage facial landmark set 1106 and the local features 1108, and organize the local features 1108 based on correlations among the local features 1108 to obtain the current stage facial landmark set 1110 using the local features 1108 and the previous stage facial landmark set 1106. Following the example in FIGS. 12A and 12B, referring to FIGS. 11 and 13, the step of organizing is organizing the local features (e.g. 1204) based on correlations among the local features (e.g. 1204) to obtain the current stage facial landmark set (e.g. 1312) using the local features (e.g. 1204) and the previous stage facial landmark set (e.g. 1202) .

FIG. 12A is a block diagram illustrating a plurality of facial landmark-specific local feature mapping functions ϕ₃₇^{t}( ), ϕ₃₈^{t}( ), . . . , and ϕ₄₈^{t}( ) used in the local feature extracting module 1102 (in FIG. 11) of the beginning stage R₁ of the cascaded regression stages R₁ to R_{M} (in FIG. 10) in accordance with an embodiment of the present disclosure. Referring to FIGS. 12A and 12B, the local feature extracting module 1102 of the beginning stage R₁ extracts each (e.g. 1210) of the local features 1204 by performing operations including mapping the facial landmark-specific local region (e.g. 1206) around the corresponding facial landmark (e.g. facial landmark (37)) the previous stage facial landmark set 1202 into each (e.g. 1210) of the local features 1204 according to a corresponding facial landmark-specific local feature mapping function (e.g. ϕ₃₇^{t}( )) of facial landmark-specific local feature mapping functions ϕ₃₇^{t}( ), ϕ₃₈^{t}( ), . . . , and ϕ₄₈^{t}( ). The facial landmark-specific local feature mapping functions ϕ₃₇^{t}( ), ϕ₃₈^{t}( ), . . . , and ϕ₄₈^{t}( ) are independent. Each of the facial landmark-specific local feature mapping functions ϕ₃₇^{t}( ), ϕ₃₈^{t}( ), . . . , and ϕ₄₈^{t}( ) is denoted by an expression (1) as shown in the following.

$${ϕ}_{l}^{t} ( ) , \qquad ( 1 )$$

where l denotes an l th facial landmark as illustrated in FIG. 3, t denotes a tth stage of the cascaded regression stages R₁ to R_{M}. Each (e.g. 1210) of the local features 1204 is denoted by an expression (2) as shown in the following.

$${ϕ}_{l}^{t} ( {I}_{c} , {S}_{c}^{l - 1} ) , \qquad ( 2 )$$

where I_{c} denotes a facial component-specific local region having a separately considered facial component c, such as the facial component-specific local region 506 having the two eyes, and s_{c}^{t-1} denotes a previous stage facial landmark set corresponding to the separately considered facial component c, such as the previous stage facial landmark set 1202 corresponding to the two eyes.

In the above embodiment, the local features 1204 are extracted using the independent facial landmark-specific local feature mapping functions ϕ₃₇^{t}( ), ϕ₃₈^{t}( ), . . . , and ϕ₄₈^{t}( ). Other ways to extract local features such as using Local Binary Pattern (LBP) or Scale Invariant Feature Transform (SIFT) are within the contemplated scope of the present disclosure.

FIG. 12B is a block diagram illustrating one of the facial landmark-specific local feature mapping functions ϕ₃₇^{t}( ), ϕ₃₈^{t}( ), . . . , and ϕ₄₈^{t}( ) in FIG. 12A implemented by a random forest 1208 in accordance with an embodiment of the present disclosure. Referring to FIGS. 12A and 12B, in an embodiment, each of the facial landmark-specific local feature mapping functions ϕ₃₇^{t}( ), ϕ₃₈^{t}( ), . . . , and ϕ₄₈^{t}( ) is implemented by a corresponding random forest. The facial landmark-specific local feature mapping functions ϕ₃₇^{t}( ) implemented by the random forest 1208 is used as an example for illustration. The description for the facial landmark-specific local feature mapping functions ϕ₃₇^{t}( ) can be applied mutatis mutandis to the other facial landmark-specific local feature mapping functions ϕ₃₇^{t}( ), ϕ₃₈^{t}( ), . . . , and ϕ₄₈^{t}( ). The random forest 1208 includes a plurality of decision tress 1212 and 1214. Each of the decision trees 1212 and 1214 includes at least one split node 1216 and at least one leaf node 1218. Each of the at least one split node 1216 decides whether to branch to the left or right. Each of the at least one leaf node 1218 is associated with continuous prediction for a regression target during training. The facial landmark-specific local region 1206 around the facial landmark (37) of the previous stage facial landmark set 1202 traverses the decision trees 1212 and 1214 until reaching one leaf node 1218 for each of the decision trees 1212 and 1214.

In an embodiment, the facial landmark-specific local region 1206 is a circular region of radius Rand centered on a position of the facial landmark (37). The local feature 1210 is a vector that includes bits each of which corresponds to a corresponding leaf node 1218 of the random forest 1208. The one leaf node 1218 for each of the decision trees 1212 and 1214 that is reached to by the facial landmark-specific local region 1206 corresponds to a bit of the local feature 1210 that has a value of “1”. Each of other bits of the local feature 1210 has a value of “0”.

In the above embodiment, each of the facial landmark-specific local feature mapping functions ϕ₃₇^{t}( ), ϕ₃₈^{t}( ), . . . , and ϕ₄₈^{t}( ) is implemented by the random forest 1208. Other ways to implement each of facial landmark-specific local feature mapping functions such as using a convolutional neural network are within the contemplated scope of the present disclosure. In the above embodiment, the facial landmark-specific local region 1206 is of a circular shape. Other shapes of a facial landmark-specific local region such as a square, a rectangle, and a triangle are within the contemplated scope of the present disclosure.

FIG. 13 is a block diagram illustrating a local feature concatenating module 1302, a facial component-specific projecting module 1304, and a facial landmark set incrementing module 1306 in the local feature organizing module 1104 in FIG. 11 in accordance with an embodiment of the present disclosure. The local feature organizing module 1104 includes the local feature concatenating module 1302, the facial component-specific projecting module 1304, and the facial landmark set incrementing module 1306. The local feature concatenating module 1302 is configured to receive the local features 1204 and concatenate the local features 1204 into a facial component-specific feature 1308. The facial component-specific projecting module 1304 is configured to receive the facial component-specific feature 1308, perform a facial component-specific projection on the facial component-specific feature 1308 corresponding to the facial component-specific local region 506 (shown in FIG. 12A) according to a facial component-specific projection matrix, and output a facial landmark set increment 1310. The facial landmark set increment 1310 is obtained by an equation (3) as shown in the following.

$$Δ {S}_{c}^{l} = {W}_{c}^{l} {Φ}_{c}^{l} ( {I}_{c} , {S}_{c}^{l - 1} ) , \qquad ( 3 )$$

where Δs_{c}^{t} denotes a facial landmark set increment corresponding to a separately considered facial component c at stage t, such as the facial landmark set increment 1310, w_{c}^{t} denotes a facial component-specific projection matrix corresponding to the separately considered facial component c at stage t, ϕ_{c}^{t}(l_{c}, s_{c}^{t-1}) denotes a facial component-specific feature corresponding to a separately considered facial component c at stage t, such as the facial component-specific feature 1308.

In an embodiment, the facial component-specific projection matrix w_{c}^{t} is a linear projection matrix. The facial landmark set incrementing module 1306 receives the facial landmark set increment 1310 and the previous stage facial landmark set 1202, and applies the facial landmark set increment 1310 to the previous stage facial landmark set 1202 to obtain the current stage facial landmark set 1312.

FIG. 14 is a block diagram illustrating cascaded training stages T₁ to T_{P} or the cascaded regression stages R₁ to R_{M} in FIG. 10 in accordance with an embodiment of the present disclosure. Each of the cascaded training stages T₁ to T_{P} is configured to receive a plurality of training sample facial component-specific local regions 1402, a plurality of ground truth facial landmark sets 1404 corresponding to the training sample facial component-specific local regions 1402, and a plurality of previous stage facial landmark sets 1506 (labeled in FIG. 15) corresponding to the training sample facial component-specific local regions 1402. Each of the training sample facial component-specific local regions 1402 is defined using a training sample facial image and includes a same type of separately considered facial components. Each of the cascaded training stages T₁ to T_{P} is further configured to train a plurality of facial landmark-specific local feature mapping functions 1408 and a facial component-specific projection matrix 1410 using the training sample facial component-specific local regions 1402, the ground truth facial landmark sets 1404, and the previous stage facial landmark sets 1506. The facial landmark-specific local feature mapping functions 1408 are, for example, correspondingly used as the facial landmark-specific local feature mapping functions ϕ₃₇^{t}( ), ϕ₃₈^{t}( ), . . . , and ϕ₄₈^{t}( ) in FIG. 12A. The facial component-specific projection matrix 1410 is, for example, used as the facial component-specific projection matrix w_{c}^{t} in FIG. 12B, where the separately considered facial component c is the two eyes. Each of the cascaded training stages T₁ to T_{P-1} is further configured to output a plurality of current stage facial landmark sets 1514 (labeled in FIG. 15) corresponding to the training sample facial component-specific local regions 1402. The previous stage facial landmark sets 1506 corresponding to a beginning stage T1 of the cascaded regression stages T₁ to T_{P} is a plurality of facial landmark sets 1406. Each of the facial landmark sets 1406 may be obtained similarly as the facial landmark set 514 described with reference to FIGS. 4 and 5. The current stage facial landmark sets 1514 for a stage Tₜ (labeled in FIG. 15) of the cascaded regression stages T₁ to T_{P-1} becomes the previous stage facial landmark sets 1506 for another stage Tₜ₊₁ immediately following the stage Tₜ.

FIG. 15 is a block diagram illustrating a facial landmark-specific local feature mapping function training module 1502 and a facial component-specific projection matrix training module 1504 in each stage Tₜ of the cascaded training stages T₁ to T_{P} in FIG. 14 in accordance with an embodiment of the present disclosure. Each stage Tₜ of the cascaded training stages T₁ to T_{P} includes a facial landmark-specific local feature mapping function training module 1502 and a facial component-specific projection matrix training module 1504.

The facial landmark-specific local feature mapping function training module 1502 is configured to receive the training sample facial component-specific local regions 1402, the ground truth facial landmark sets 1404, and the previous stage facial landmark sets 1506, and train each of the facial landmark-specific local feature mapping functions 1408 independently from each other and output a plurality of local feature sets 1512 corresponding to the training sample facial component-specific local regions 1402, using the training sample facial component-specific local regions 1402, the ground truth facial landmark sets 1404, and the previous stage facial landmark sets 1506. In an embodiment, each of the facial landmark-specific local feature mapping functions 1408 is obtained by minimizing an objective function (4) as shown in the following.

$${min}_{{w}^{t} , {ϕ}_{l}^{t}} {Σ}_{i = 1} {‖ {π}_{l} ∘ Δ {{S}^{⋁}}_{i}^{t} - {w}_{l}^{t} {ϕ}_{l}^{t} ( {I}_{i} , {S}_{i}^{t - 1} ) ‖}_{2}^{2} , \qquad ( 4 )$$

where t represents a tth stage of the cascaded training stages T₁ to T_{P} in FIG. 14, i iterates overall the training sample facial component-specific local regions 1402, l represents an lth facial landmark as illustrated in FIG. 3, Δs̆ᵢ^{t} is a ground truth facial landmark set increment corresponding to the ith training sample facial component-specific local region at the tth stage, πl extracts two elements (2l, 2l-1) from the ground truth facial landmark set increment Δs̆ᵢ^{t}, πₗ∘Δs̆ᵢ^{t} is a 2D offset of the lth facial landmark in the ith training sample facial component-specific local region, Iᵢ is the ith training sample facial component-specific local region, sᵢ^{t-1} is a previous stage facial landmark set corresponding to the ith training sample facial component-specific local region such as one of the previous stage facial landmark sets 1506, ϕₗ^{t}( ) is a facial landmark-specific local feature mapping function corresponding to the lth facial landmark at the tth stage, such as one of the facial landmark-specific local feature mapping functions 1408, ϕₗ^{t}(Iᵢ, sᵢ^{t-1}) is a local feature corresponding to lth facial landmark and the ith training sample facial component-specific local region at the tth stage, such as one local feature of one local feature set of the local feature sets 1512, wₗ^{t} is a local linear regression matrix for mapping a the local feature ϕₗ^{t}(Iᵢ, sᵢ^{t-1}) into a 2D offset. The ground truth facial landmark set increment Δs̆ᵢ^{t} is obtained by an equation (5) as shown in the following.

$$Δ {{S}^{⋁}}_{i}^{l} = {{S}^{⋁}}_{i}^{l} - {S}_{i}^{l - 1} , \qquad ( 5 )$$

where s̆ᵢ^{t} is a ground truth facial landmark set corresponding to the ith training sample facial component-specific local region at the tth stage such as one of the ground truth facial landmark sets 1404, and sᵢ^{t-1} is a previous stage facial landmark set corresponding to the ith training sample facial component-specific local region such as one of the previous stage facial landmark sets 1506. The local linear projection matrix wₗ^{l} is a 2-by-D matrix, where D is a dimension of the local feature ϕₗ^{t}(Iᵢ, sᵢ^{t-1}).

A standard regression random forest is used to learn each facial landmark-specific local feature mapping function ϕₗ^{t}( ). An example of the random forest corresponding to a learned facial landmark-specific local feature mapping function is the random forest 1208 corresponding to the facial landmark-specific local feature mapping function ϕ₃₇^{t}( ) described with reference to FIG. 12B. Split nodes in the random forest are trained using the pixel-difference feature.

To train each split node in the random forest, 500 randomly sampled pixel features are chosen from a facial landmark-specific local region around a facial landmark, and the feature that gives rise to a maximum variance reduction is picked. The facial landmark-specific local region is similar to the facial landmark-specific local region 1206 described with reference to FIG. 12B. After training, each leaf node stores a 2D offset vector that is the average of all the training sample facial component-specific local regions 1402 in each leaf node.

During testing, each of the training sample facial component-specific local regions 1402 traverses the random forest and compare the pixel-difference feature of each of the training sample facial component-specific local regions 1402 with each node until each of the training sample facial component-specific local regions 1402 reaches a leaf node. For each dimension in the local feature ϕₗ^{t}(Iₗ, sᵢ^{t-1}), a value of each dimension is “1” if the ith training sample facial component-specific local region reaches a corresponding leaf node, and “0” other wise.

The facial component-specific projection matrix training module 1504 is configured to receive ground truth facial landmark set increments 1510 and the local feature sets 1512, and train facial component-specific projection matrix 1410 and output the current stage facial landmark sets 1514, using the ground truth facial landmark set increments 1510 and the local feature sets 1512. Each of the ground truth facial landmark set increments 1510 is the ground truth facial landmark set increment Δs̆ᵢ^{t} in the objective function (4) . Facial component-specific projection matrix 1410 is trained using the local feature sets 1512 corresponding to the training sample facial component-specific local regions 1402 including the same type of separately considered facial components, but not local feature sets corresponding to training sample facial component-specific local regions including other types of separately considered facial components. In an embodiment, the facial component-specific projection matrix 1410 is obtained by minimizing an objective function (5) as shown in the following.

$${min}_{{w}^{t}} {Σ}_{i = 1} {‖ Δ {{S}^{⋁}}_{i}^{l} - {W}_{c}^{t} {Φ}_{c}^{t} ( {I}_{i} , {S}_{i}^{l - 1} ) ‖}_{2}^{2} + λ ‖ {W}^{t} ‖ , \qquad ( 5 )$$

where the first term is the regression target, Φ_{c}^{t}(Iᵢ, sᵢ^{t-1}) is a facial component-specific feature corresponding to the ith training sample facial component-specific local region at the tth stage, w_{c}^{t} is a facial component-specific projection matrix such as the facial component-specific projection matrix 1410, the second term is an L1 regularization on w_{c}^{t}, and λ controls the regularization strength. The facial component-specific feature Φ_{c}^{l}(Iᵢ, sᵢ^{t-1}) is the concatenated local features, wherein each local feature of the concatenated local features is the local feature ϕₗ^{t}(Iᵢ, sᵢ^{t-1}) described with reference to the objective function (4). Any optimization technique such as Single Value Decomposition (SVD), gradient descent, or dual coordinate descent may be used. Each of the current stage facial landmark sets 1514 is w_{c}^{t}Φ_{c}^{t}(Iᵢ, sᵢ^{t-1}) after the facial component-specific projection matrix w_{c}^{t} is obtained.

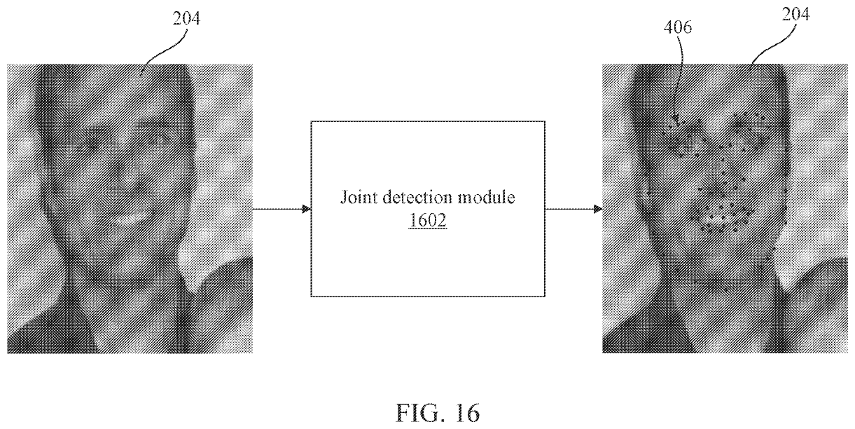

FIG. 16 is a block diagram illustrating a joint detection module 1602 implementing the global facial landmark obtaining module 402 in FIG. 4 in accordance with an embodiment of the present disclosure.

In an embodiment, the global facial landmark obtaining module 402 is implemented using a joint detection module 1602. The joint detection module 1602 is configured to receive the facial image 204 and perform a joint detection method using the facial image 204 to obtain a facial shape 406.

The joint detection method obtains facial landmarks corresponding to a plurality of facial components in a facial image together. For example, the joint detection method obtains the facial landmarks (1) to (17) corresponding to the facial contour in the facial image 204, the facial landmarks (18) to (27) corresponding to the eyebrows in the facial image 204, the facial landmarks (37) to (48) for the eyes in the facial image 204, the facial landmarks (28) to (36) for the nose in the facial image 204, and the facial landmarks (49) to (68) for the mouth in the facial image 204 together. In an embodiment, the joint detection method is a cascaded regression method that extracts a plurality of local features using the facial image 204, concatenates the local features into a global feature, and performs a joint projection on the global feature to obtain a facial shape for a current stage.

A joint projection matrix used when the joint projection is performed is trained using a regression target that involves facial landmarks of a plurality of facial components such as a facial contour, eyebrows, eyes, a nose, and a mouth.

In another embodiment, the joint detection method is a deep learning facial landmark detection method that includes a convolutional neural network that has a plurality of levels at least one of which obtains facial landmarks corresponding to a plurality of facial components in a facial image together.

In the above embodiment, the global facial landmark obtaining module 402 is implemented using the joint detection method. Other ways to implement the global facial landmark obtaining module 402 such as using a random guess or a mean facial shape obtained from training samples are within the contemplated scope of the present disclosure.

Some embodiments have one or a combination of the following features and/or advantages. In a related art, a cascaded regression method which is also a joint detection method extracts a plurality of local features using a facial image, concatenates the local features into a global feature, and performs a joint projection on the global feature to obtain a facial shape for a current stage.

A joint projection matrix used when the joint projection is performed is trained using a regression target that involves facial landmarks of a plurality of facial components such as a facial contour, eyebrows, eyes, a nose, and a mouth. Therefore, optimization for the joint projection matrix involves all of the facial components together.

In this way, for example, during optimization, changes for the facial landmarks for the nose, affect changes for the facial landmarks for the facial contour, the eyebrows, the eyes, and the mouth. When the nose is abnormal, training for the joint projection matrix is adversely impacted, resulting in the joint projection matrix that is not only not optimal for a nose, but also not optimal for a facial contour, eyebrows, eyes and a mouth during an inference stage.

Compared to the related art, some embodiments of the present disclosure defines a plurality of facial component-specific local regions using a facial image, and performs a cascaded regression method for each of the facial component-specific local regions. The cascaded regression method for some embodiments of the present disclosure extracts a plurality of local features using each of the facial component-specific local regions, concatenates the local features into a facial component-specific feature, and performs a facial component-specific projection on the facial component-specific feature to obtain a corresponding facial landmark set of a plurality of facial landmark sets for a current stage.

A facial component-specific projection matrix used when the facial component-specific projection is performed is trained using a regression target that involves the facial landmarks of only a separately considered facial component such as eyes. Therefore, optimization for the facial component-specific projection matrix involves the separately considered facial component. In this way, for example, during optimization, changes for the facial landmarks for the eyes, does not affect changes for facial landmarks for eyebrows, a nose and a mouth. When the eyes is abnormal, training for facial component-specific projection matrices for other facial components are not adversely impacted, resulting in the facial component-specific projection matrices that is optimal for the eyebrows, the nose, and the mouth during an inference stage. Furthermore, complexity for optimizing the joint projection matrix is higher than that for optimizing each of the facial component-specific projection matrices.

In a related art, a cascaded regression method such as the cascaded regression method that Performs joint detection uses a random guess or a mean facial shape as an initialization (i.e., a previous stage facial shape for a beginning stage of the cascaded regression method). Because the cascaded regression method depends heavily on the initialization, when a head pose of a facial image for which facial landmark detection is performed deviates largely from a head pose of the random guess or the mean facial shape, a performance of facial landmark detection is bad.

Compared to the related art, some embodiments of the present disclosure performs a joint detection method that coarsely detects a facial shape, and uses the facial shape as an initialization for a cascaded regression method that performs facial component-specific local refinement on each of a plurality facial landmark sets in the facial shape. The facial landmark sets correspond to separately considered facial components. Therefore, coarse to fine facial landmark detection is performed, resulting in an improvement in accuracy of a detected facial shape.

Furthermore, because facial component-specific local refinement is performed locally specific to a facial component, accuracy of the detected facial shape is gained without sacrificing speed. Table 1, below, illustrates experimental results for comparing accuracy and speed of a Supervised Descend Method (SDM) which is a cascaded regression method that uses a random guess or a mean facial shape as an initialization, and some embodiments of the present disclosure that Performs coarse to fine facial landmark detection. The SDM is described by “Supervised descent method and its applications to face alignment,” Xiong, X., De la Torre Frade, F., In: IEEE International Conference on Computer Vision and Pattern Recognition, 2013. As shown, compared to the SDM, coarse to fine facial landmark detection in some embodiments of the present disclosure is improved dramatically on a normalized mean error (NME) without sacrificing speed.

TABLE 1

| | 300 W Common | 300 W Challenge | Speed tested |
|---|---|---|---|
| Method | Set NME | Set NME | on i7 CPU |
| SDM | 5.57 | 15.4 | 30 fps |
| Coarse to fine | 4.54 | 10.30 | 30 fps |
| facial landmark | | | |
| detection | | | |

In a related art, a deep learning facial landmark detection method improves accuracy of a detected facial shape using a complicated/deep architecture. Compared to the deep learning facial landmark detection method, coarse to fine facial landmark detection in some embodiments of the present disclosure uses another deep learning facial landmark detection method that employs a shallower or narrower architecture for coarse detection and facial component-specific local refinement for fine detection. Therefore, accuracy of a detected facial shape can be improved without significantly increasing computational cost.

A person having ordinary skill in the art understands that each of the units, modules, layers, blocks, algorithm, and steps of the system or the computer-implemented method described and disclosed in the embodiments of the present disclosure are realized using hardware, firmware, software, or a combination thereof. Whether the functions run in hardware, firmware, or software depends on the condition of application and design requirement for a technical plan. A person having ordinary skill in the art can use different ways to realize the function for each specific application while such realizations should not go beyond the scope of the present disclosure.

It is understood that the disclosed system, and computer-implemented method in the embodiments of the present disclosure can be realized with other ways. The above-mentioned embodiments are exemplary only. The division of the modules is merely based on logical functions while other divisions exist in realization. The modules may or may not be physical modules. It is possible that a plurality of modules are combined or integrated into one physical module. It is also possible that any of the modules is divided into a plurality of physical modules. It is also possible that some characteristics are omitted or skipped.

On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules are located in one place or distributed on a plurality of network modules. Some or all of the modules are used according to the purposes of the embodiments.

If the software function module is realized and used and sold as a product, it can be stored in a computer readable storage medium. Based on this understanding, the technical plan proposed by the present disclosure can be essentially or partially realized as the form of a software product. Or, one part of the technical plan beneficial to the conventional technology can be realized as the form of a software product.

The software product is stored in a computer readable storage medium, including a plurality of commands for at least one processor of a system to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program instructions.

While the present disclosure has been described in connection with what is considered the most practical and preferred embodiments, it is understood that the present disclosure is not limited to the disclosed embodiments but is intended to cover various arrangements made without departing from the scope of the broadest interpret at ion of the appended claims.

What is claimed is:

1. A computer-implemented method, comprising:
performing an inference stage method, wherein the inference stage method comprises:
receiving a first facial image;
obtaining a first facial shape using the first facial image;
defining, using the first facial image and the first facial shape, a plurality of facial component-specific local regions, wherein each of the facial component-specific local regions comprises a corresponding separately considered facial component of a plurality of separately considered facial components from the first facial image, and the corresponding separately considered facial component of the separately considered facial components corresponds to a corresponding first facial landmark set of a plurality of first facial landmark sets in the first facial shape, wherein the corresponding first facial landmark set of the first facial landmark sets comprises a plurality of facial landmarks;
for each of the facial component-specific local regions, performing a cascaded regression method using each of the facial component-specific local regions and a corresponding facial landmark set of the first facial landmark sets to obtain a corresponding facial landmark set of a plurality of second facial landmark sets, wherein each stage of the cascaded regression method comprises:
extracting a plurality of local features using each of the facial component-specific local regions and a corresponding facial landmark set of a plurality of previous stage facial landmark sets,
wherein:
the step of extracting comprises extracting each of the local features from a facial landmark-specific local region around a corresponding facial landmark of the corresponding facial landmark set of the previous stage facial landmark sets, wherein the facial landmark-specific local region is in each of the facial component-specific local regions; and
the corresponding facial landmark set of the previous stage facial landmark sets corresponding to a beginning stage of the cascaded regression method is the corresponding facial landmark set of the first facial landmark sets; and
organizing the local features based on correlations among the local features to obtain a corresponding facial landmark set of a plurality of current stage facial landmark sets, wherein the corresponding facial landmark set of the current stage facial landmark sets corresponding to a last stage of the cascaded regression method is the corresponding facial landmark set of the second facial landmark sets.

2. The computer-implemented method of claim 1, wherein the separately considered facial components are separated according to facial features.

3. The computer-implemented method of claim 2, wherein the facial features are functionally grouped.

4. The computer-implemented method of claim 2, wherein the facial features are non-functionally grouped.

5. The computer-implemented method of claim 1, wherein the step of defining comprises:
defining each of the facial component-specific local regions by cropping such that separately considered facial components other than the corresponding separately considered facial component of the separately considered facial components are at least partially removed, wherein the second facial landmark sets are correspondingly located on the facial component-specific local regions which are separated.

6. The computer-implemented method of claim 5, wherein:
the first facial shape further comprises a third facial landmark set corresponding to a facial contour from the first facial image; and
the inference stage method further comprises:
merging the second facial landmark sets correspondingly located on the facial component-specific local regions which are separated and the third facial landmark set into a second facial shape.

7. The computer-implemented method of claim 1, wherein the first facial shape is obtained using a joint detection method.

8. The computer-implemented method of claim 1, wherein the step of extracting each of the local features comprises mapping the facial landmark-specific local region around the corresponding facial landmark of the corresponding facial landmark set of the previous stage facial landmark sets into each of the local features according to a corresponding facial landmark-specific local feature mapping function of facial landmark-specific local feature mapping functions.

9. The computer-implemented method of claim 8, further comprising:
performing a training stage method, wherein the training stage method comprises:
training each of the facial landmark-specific local feature mapping functions independently from each other .

10. The computer-implemented method of claim 9, wherein:
the step of organizing comprises:
concatenating the local features into a facial component-specific feature; and
performing a facial component-specific projection on the facial component-specific feature corresponding to each of the facial component-specific local regions according to a corresponding facial component-specific projection matrix of the facial component-specific projection matrices; and
the training stage method further comprises: training the corresponding facial component-specific projection matrix of the facial component-specific projection matrices using the facial landmark-specific local feature mapping functions corresponding to each of the facial component-specific local regions, but not the facial landmark-specific local feature mapping functions corresponding to the facial component-specific local regions other than each of the facial component-specific local regions.

11. The computer-implemented method of claim 1, wherein the step of organizing comprises:
concatenating the local features into a facial component-specific feature; and
performing a facial component-specific projection on the facial component-specific feature corresponding to each of the facial component-specific local regions according to a corresponding facial component-specific projection matrix of the facial component-specific projection matrices.

12. A system, comprising:
at least one memory configured to store program instructions;
at least one processor configured to execute the program instructions, which cause the at least one processor to perform steps comprising:
performing an inference stage method, wherein the inference stage method comprises:
receiving a first facial image;
obtaining a first facial shape using the first facial image;
defining, using the first facial image and the first facial shape, a plurality of facial component-specific local regions, wherein each of the facial component-specific local regions comprises a corresponding separately considered facial component of a plurality of separately considered facial components from the first facial image, and the corresponding separately considered facial component of a plurality of separately considered facial components corresponds to a corresponding first facial landmark set of the first facial landmark sets in the first facial shape, wherein the corresponding first facial landmark set of the first facial landmark sets comprises a plurality of facial landmarks;
for each of the facial component-specific local regions, performing a cascaded regression method using each of the facial component-specific local regions and a corresponding facial landmark set of the first facial landmark sets to obtain a corresponding facial landmark set of a plurality of second facial landmark sets, wherein each stage of the cascaded regression method comprises:
extracting a plurality of local features using each of the facial component-specific local regions and a corresponding facial landmark set of a plurality of previous stage facial landmark sets,
wherein:
the step of extracting comprises extracting each of the local features from a facial landmark-specific local region around a corresponding facial landmark of the corresponding facial landmark set of the previous stage facial landmark sets, wherein the facial landmark-specific local region is in each of the facial component-specific local regions; and
the corresponding facial landmark set of the previous stage facial landmark sets corresponding to a beginning stage of the cascaded regression method is the corresponding facial landmark set of the first facial landmark sets; and
organizing the local features based on correlations among the local features to obtain a corresponding facial landmark set of a plurality of current stage facial landmark sets, wherein the corresponding facial landmark set of the current stage facial landmark sets corresponding to a last stage of the cascaded regression method is the corresponding facial landmark set of the second facial landmark sets.

13. The system of claim 12, wherein the separately considered facial components are separated according to facial features.

14. The system of claim 13, wherein the facial features are functionally grouped.

15. The system of claim 13, wherein the facial features are non-functionally grouped.

16. The system of claim 12, wherein the step of defining comprises:
defining each of the facial component-specific local regions by cropping such that separately considered facial components other than the corresponding separately considered facial component of the separately considered facial components are at least partially removed, wherein the second facial landmark sets are correspondingly located on the facial component-specific local regions which are separated.

17. The system of claim 16, wherein:
the first facial shape further comprises a third facial landmark set corresponding to a facial contour from the first facial image; and
the inference stage further comprises:
merging the second facial landmark sets correspondingly located on the facial component-specific local regions which are separated and the third facial landmark set into a second facial shape.

18. The system of claim 12, wherein the first facial shape is obtained using a joint detection method.

19. The system of claim 12, wherein the step of extracting each of the local features comprises mapping the facial landmark-specific local region around the corresponding facial landmark of the corresponding facial landmark set of the previous stage facial landmark sets into each of the local features according to a corresponding facial landmark-specific local feature mapping function of facial landmark-specific local feature mapping functions.

20. The system of claim 19, further comprising:
performing a training stage method, wherein the training stage method comprises:
training each of the facial landmark-specific local feature mapping functions independently from each other.
